(19) United States
(12) Patent Application Publication
(10) Pub. No.: US 2003/0227228 A1
(43) Pub. Date: Dec. 11, 2003

(54) Basic magnetic radiation -methods and motor

(76) Inventor: Traian Cherciu, Belleville, NJ (US)

Correspondence Address: TRAIAN CHERCIU, 426 DE WITT AVE., BELLEVILLE, NJ, 07109, US

(21) Appl. No.: 10/166,847

(22) Filed: Jun. 11, 2002

(51) Int. Cl. H02K 21/00

(52) U.S. Cl. 310/152

(57) ABSTRACT

This patent application presents three methods of detection of Basic Magnetic Radiation (BMR) a nonpollution and high capacity source of energy witch is independent of time and space and a method of converting it into electrical energy, by using electrical means, an assembly made of an electrical generator of counter rotation and an electrical motor of counter rotation

### FIELD OF INVENTION

This patent presents, a time and space independent source of energy that is used in today's market with a low efficiency. The patent application describes three methods of monitoring the effects produced by this unconventional source of energy and one way of using this energy by improving the standard electric motors and generators.

Due to the nature of the effects produced by this unconventional source it will be referred to in this invention as BASIC MAGNETIC RADIATION (BMR abbreviated).

BMR is one of the effects of physical phenomenon of conversion that is constantly taken place in nature and that can be measured by current electric means.

### BRIEF SUMMARY OF THE INVENTION

Due to the current demographic explosion that is taken place in the world there is an ever-escalating energy demand that has the following disadvantages:

Rapid reduction and decay of the natural energy reserves that are in limited supply.

Efficiency of conversion of the power motors and engines is inferior to the conditions prevalent in nature.

The local economy dependence on the oil producing countries;

The pollution of the environment and the radioactive waste by products are escalating out of control.

BMR as an alternative is a time and space independent source of energy that can be easily converted into mechanical and electrical energy with a low investment compared to the traditional technology.

The main means of converting the BMR into mechanical or electrical energy are comprised of a generator-motor assembly having as principal parts a stator, a rotor, an inductor, an armature and a startup source.

### DETAILED DESCRIPTION OF THE INVENTION

### Basic Magnetic Radiation-Methods

It is known that the potential status of attraction or rejection between magnets is taken place without any quantitative or qualitative changes, which is contrary to the changes that can be recorded in the case of conventional energy sources.

According to the above observation, one can prove theoretically and experimentally that magnets and electromagnets are detecting a great natural radiation that is converted in electromagnetic and mechanic energy as it is shown in the following 3 variations of the patent application.

Variation 1—Power Balance

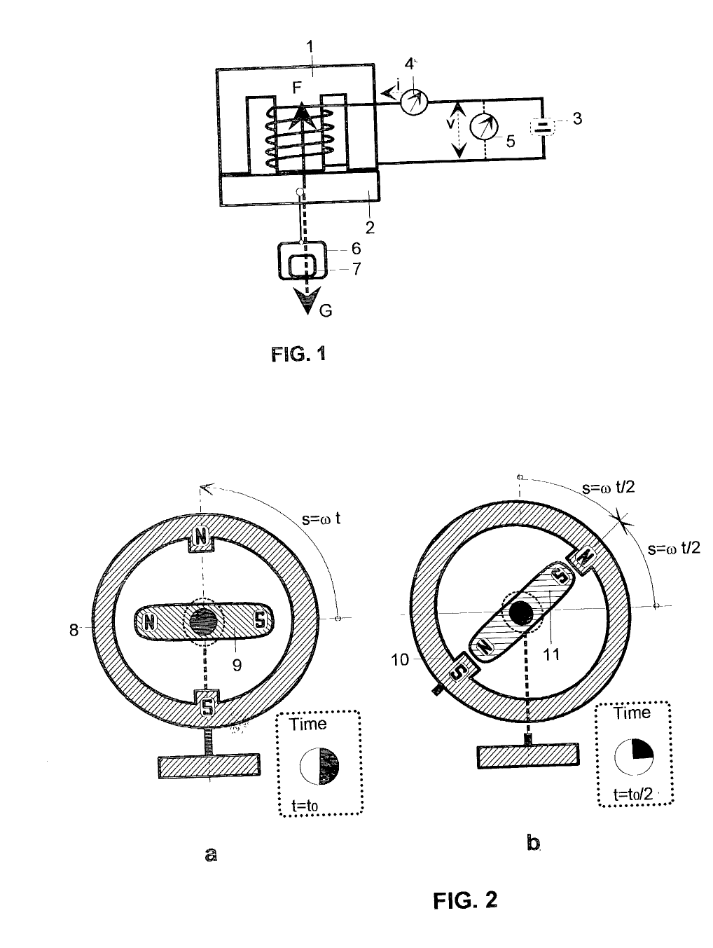

The main effect of the BMR can be detected by an electromagnet as illustrated in FIG. 1 where an electromagnet (1) having a closure casing (2), a DC power source (3), an ampere meter (4), a voltmeter (5), a tray of a scale (6) suspended by the closure casing and various weights (7).

In this case for a given voltage (U) and for a given electrical current (I) consumed by electromagnet, one can calculate the electrical power based on the formula Pi=U I, and by loading the scale with different weights, one can determine the maximum weight G, up to which the electromagnetic force slightly exceeds the suspended weight.

By comparing the consumed electrical power by the electromagnet Pi to the mechanical power Po required for the suspension of the weight G, one can observe that the mechanical power produced by the electromagnet Po=G g/2 exceeds the consumed electrical power (g=9.81 m/sec gravitational acceleration)

Using an ordinary electromagnet one can experimentally prove that Po>50 Pi.

This observation represents the first evidence that the electromagnet is located in an unknown energy field which is detected and converted in a supplementary mechanical energy Ps=Po−Pi. This first evidence is highly debatable since there is no mechanical work between the electromagnet casing (1) and the closure casing (2) and therefore one can not calculate the mechanical work and power required for the weight loading, but here is noteworthy that during the process of weight loading the electrical power of feeding the electromagnet is constant, independent of the suspended weight, which can be compared to a stationary helicopter flying at a constant altitude in which case the engine's power is dependent to suspended load and there is too no mechanical work between the helicopter's engine and the load.

Variation 2—Intensity of the Radiation

BMR can be theoretically founded as it is shown following example:

For the device shown in FIG. 1, the electromagnetic force (F) can be obtained using the following formula:

F=B A/2μ₀ [1]

Where B−inductance; A−cross section of casings; μ₀−absolute permeability.

Based upon the electrical energy feeding, for the electromagnetic force, (when A_{f}≅Aₐ=A) one can determine the following formula (2):

F₍ₓ₎=[N²I²A μ₀/2]/[(x²/l)+(2l_{f}x/μ_{rf})+(l_{f}²/μ_{rf}²)] [2]

Where

F—magnetic force based upon the gap x

N—number of loops on the coil

I—coil's electrical current

A—cross section area of the casings

μ_{0□}—absolute permeability

μ_{rf} relative permeability of the casings

l_{f}—length of the magnetic lines in the casings

a—initial gap

b—final gap

In the case of an initial gap in the range of few millimeters, the closing of the casings' magnetic circuit, in a time interval of 0.1 sec., one can calculates follows the electrical feeding; energy and the mechanical work.

The mechanical work (W) can be calculated using the following formula:

$$W = {\int }_{a}^{b} {F}_{( x )} ⅆ x \qquad [ 3 ]$$

By comparing (W) the mechanical work at output, with (Ei) the electrical energy consumed during the closing period of the electromagnetic circuit (t=0.1 sec.) Ei=UIt it is obvious that the mechanical work W is greater that the consumed electrical energy Eᵢ.

W>>Eᵢ

Variation 3—Electrical Assembly Motor—Generator of Counter Rotation.

OR (The method of mechanical superposition of action and reaction)

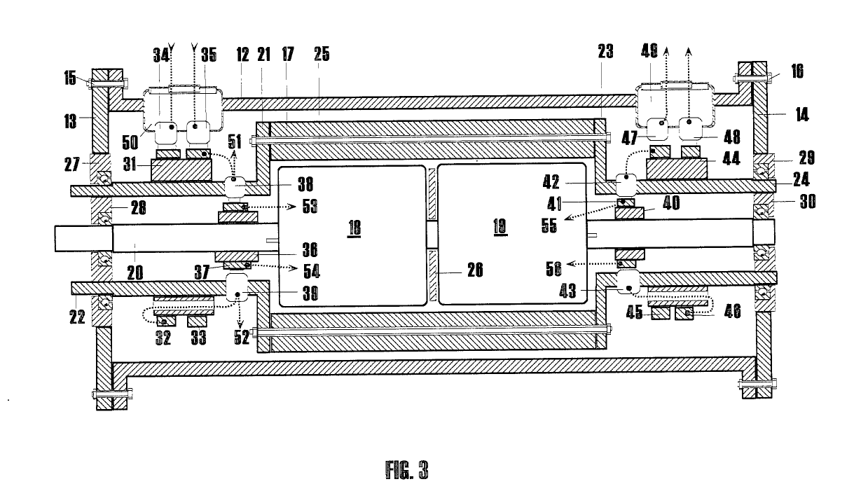

The method of mechanical superposition of action and reaction materialized as illustrated in FIG. 2, a case in which an electrical motor of counter rotation composed 2 active parts that are consuming about the same amount of electrical energy, the first part named rotor (9) and the second part named stator (8). In the conventional technology it is known that only the rotor producing the mechanical work and that the stator is a reaction.

What has been largely unknown it is that the stator can also produce a mechanical work equal to the one produced by rotor and therefore doubling the efficiency, conservation of energy and reducing pollution.

By disconnecting the stator from its fixed base, as it is illustrated in FIG. 2b, the stator (10) is rotating in a direction opposite of the rotor (11) and we have a new electrical motor of counter rotation.

The electrical motor of counter rotation has the following characteristics:

At equal speeds of counter rotation, assuming an 360°/8 angle for the rotor rotating one way and the stator the opposite way, the total mechanical work produced by the rotor and stator is double of the total mechanical work produced by a conventional motor during the same time interval, therefore output power, torque and efficiency are doubled—FIG. 2a and FIG. 2b.

It is known that the efficiency of conventional motors can reach 97% and so therefore become known that the electrical motor of counter rotation could reach efficiency of 194%, which only apparently violates the principle of energy conservation.

The efficiency of 194% can be motivated only by considering the existence of a supplementary source of energy that manifests itself in the confines of the electrical motor of counter rotation where the active parts contain electromagnets.

It is evident that electromagnets and magnets have the quality of detecting and converting this supplementary source of energy, so how it is referred in this application.

It is known that the onboard instrumentation of a space shuttle can operate at high altitude, in outer space and so therefore become known that BMR is independent of time and space.

A new method of converting BMR into mechanical or electrical energy is by connecting an electric motor of counter rotation to an electric generator of counter rotation and by using an auxiliary source of start up.

The motor using BMR is described in the following drawings:

FIG. 1 is a diagram of the BMR detecting device with one electromagnet

FIGS. 2a and 2b are two cross sections of the electrical motor, that illustrates the principal elements.

FIG. 3 is a longitudinal section of the motor with BMR—EMBODIMENT1—having a DC electrical motor and a DC electrical generator.

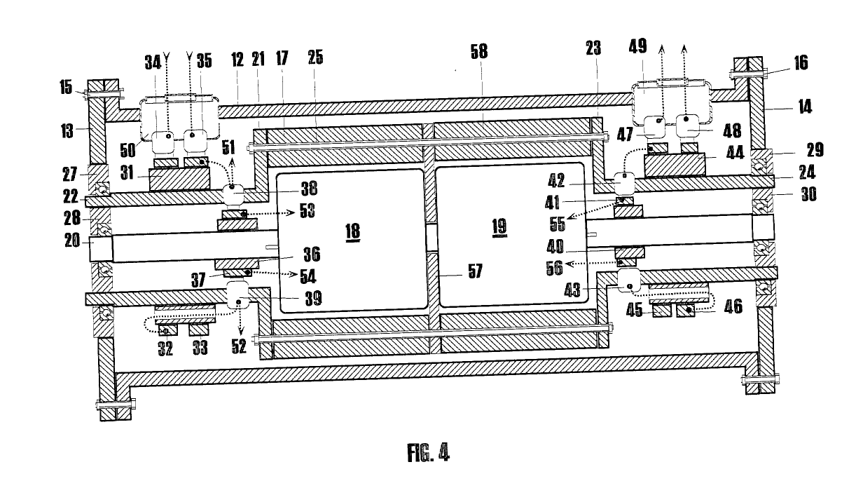

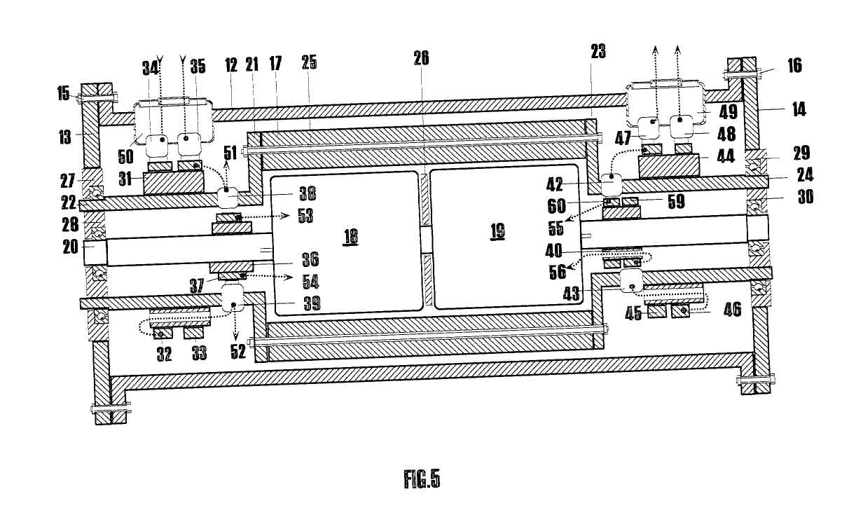

FIG. 4 is a longitudinal section of the motor with BMR—EMBODIMENT 2—having a DC electrical motor and an DC electrical generator with a self-inductor

FIG. 5 is a longitudinal section of the motor with BMR—EMBODIMENT 3—having an universal electric motor and an AC electrical generator.

### DETAILED DESCRIPTION OF PREFERRED EMBODIMENTS

Embodiment 1

According to FIG. 3 the motor with BMR contains two assemblies, the first one motor, a DC electrical motor of counter rotation and the second one generator, a DC electrical generator of counter rotation that are mechanically coupled with motor and mounted in a common cylindrical housing 12. The common cylindrical housing has two orifices for the fixing of the port brushes boxes 49, 50 and is confined by two walls 13, 14 having orifices through which the rolling systems for the moving parts are mounted, bearings 27,28, 29 and 30.

The first assembly, the motor is comprised of two main parts. The first part, the stator-inductor of counter rotation 17 with its coils, which is extended in the generator area where is also acting as an inductor. The stator-192 inductor is suspended by two frames 21 and 23, frames that are extended tubular concentric with the central shaft 20, extensions that constitute the two parts of the secondary motor shaft 22 and 24.

The electrical feeding of the stator-inductor, from an auxiliary source of start up, is accomplished by the pair of brushes 34, 35, through the slipping rings 32, 33 and through the coils terminals 51, 52.

The second main part of the motor, a rotor 18 is mounted on the main motor shaft 20 in the interior of the stator-inductor. The electrical feeding of the rotor coils is accomplished by a pair of brushes 34 and 35 which are mounted into the box of brushes 50, through the slipping rings 32 and 33, through brushes 38 and 39 that are located diametrically opposed on the secondary motor shaft 22, through the commutator 37 and the rotor coil terminals 53 and 54. The electrical insulation of the slipping rings 32 and 33 is accomplished by an insulation bush 31 that is mounted on the secondary motor shaft 22, bush that has an orifice through which the slipping ring 32 and the brush 52 are electrically connected. The electrical insulation of the commutator 37 is accomplished by an insulating bush 36 that is mounted on the main motor shaft 20.

The second assembly, an electrical generator of counter rotation, contains two main parts. The first main part, the inductor, is a stator-inductor of counter rotation 17 that is extended in the generator from motor area.

The second main part, an armature 19 with its coils, is engaged in a rotational direction that is opposed to that of the stator-inductor and that is attached to the main motor shaft 20. The electrical current through the armature coils is being collected at the coils terminals 55 and 56, through commutator, through brushes 42 and 43 that are located diametrically opposed on the secondary shaft 24, through the slipping rings 45 and 46 and through brushes 47 and 48, brushes that are located in the port brush box 49. The electrical insulation for the commutator and for the slipping rings is being accomplished by two bushes 40 and 44, made of insulating material, the bush 44 having an orifice for the electrical connection between brush 43 and ring 46. The disc 26 is accomplishing the separation of the components mounted on the principal motor shaft 20. The mechanical connection of the parts of the assembly (motor) is being done by a set of nuts and bolts 15, 16 and 25.

Embodiment 2

According to FIG. 4 this embodiment differs from the first one by separating the inductor 58 from the stator 17 through the insulating disc 57.

Embodiment 3

According to FIG. 5 this embodiment differs from the first one by having an universal electrical generator of counter rotation and by replacing the commutator 41 with two slipping rings 59 and 60

I claim:

1. A method for improvement of an electrical assembly generator-motor, characterized by a consumption of BMR and converting it into electrical energy, by using an assembly made of an electrical generator of counter rotation and an electrical motor of counter rotation, comprising the steps of:
A. adaptation the electrical generators for counter rotation by;
a. disconnecting the inductor from the housing;
b. providing support to the inductor and armature by means of suspension;
c. suspending the inductor free from the housing for rotation around the central axis in a direction opposite of the armature under action of one electrical motor of counter rotation;
d. providing the inductor with two frames and a tubular shaft having a common central axis;
e. providing electrical means for feeding the inductor and for the output current;
B. mechanical coupling of the electrical generators of counter rotation to the electrical motors of counter rotation, so coupling the rotating inductor with the rotating stator and the armature with the rotor;
C. electrical feeding of the motors and generators from an auxiliary source of start up;
D. changing of the electrical feeding of the motors from the start up source to the current produced by the generators;
steps through accomplished:
E. relative efficiencies is up to 194%, due to a consumption of the BMR;
F. reduction of the consumption of natural resources, which are in limited supply;
G. reduction of up to 50% of the weight and raw materials for energy producing technology;
H. reduction of pollution;
I. reduction of the local economy dependence on the oil producing countries;

2. A convector unit characterized of converting the BMR, a natural radiation into an electric current, comprised of an electric motor of counter rotation and an electric generator of counter rotation.

3. An improved electric generator of counter rotation, as per claim 2, having a common housing with an electric motor of counter rotation, comprised of two rotatable assemblies enclosed within the housing, the first assembly a rotatable armature and the second assembly a rotatable inductor, the armature and the inductor being supported by separate suspension means for rotation in opposite direction around a common central axis under action of electric motor and so under influence of the electromagnetic fields developed during rotation of stator and rotor, said rotatable inductor further comprising two frames, a left frame tubular extended, concentric around a central axis, with electrical means for electrical feeding of motor and a right frame tubular extended with electrical means for current output.

4. An improved electrical motor of counter rotation, as per claim 2, having a housing common with an electric generator, comprised of two rotatable parts, the first part a rotor and the second part a rotatable stator, the rotor and the stator supported by separate suspension means for rotation in opposite direction around a common central axis under influence of the electromagnetic fields developed of stator and of rotor, said rotatable stator part further, extended in generator area, so an inductor, comprising a stator left frame tubular extended with means for electrical feeding of motor, a right frame tubular extended with electrical means for output current.
